(19) United States
(12) Patent Application Publication
(10) Pub. No.: US 2014/0214642 A1
(43) Pub. Date: Jul. 31, 2014

(54) System and Method for Determining Payment Card Benefits

(71) Applicant: MASTERCARD INTERNATIONAL INCORPORATED, (US)

(72) Inventors: Marlowe Valdeabella, Ballwin, MO (US); Kiran Shenoy, OFallon, MO (US); Natalie Christine Shatzman, Webster Groves, MO (US)

(73) Assignee: MASTERCARD INTERNATIONAL INCORPORATED, Purchase, NY (US)

(21) Appl. No.: 13/756,015

(22) Filed: Jan. 31, 2013

(51) Int. Cl. G06Q 30/00

(52) U.S. Cl. CPC G06Q 30/016
USPC 705/35

(57) ABSTRACT

A system and method for determining payment card benefits (e.g., rental car insurance, roadside assistance, extended warranty on purchases, price protection, emergency travel assistance, no foreign transaction fees, hotel and airline upgrades, and the like). The system comprises an electronic storage device having a database of payment card benefit information stored therein; an access path for allowing access to the payment card benefit information; and a processor for assembling the payment card benefit information in the database, and for providing the assembled payment card benefit information to a cardholder that has been granted access to the database. The present disclosure also relates to a system and method for determining geographic location of a call center associated with payment card benefits.

### BACKGROUND OF THE DISCLOSURE

1. Field of the Disclosure

The present disclosure relates to a system and method for determining payment card benefits. The present disclosure also relates to a system and method for determining geographic location of a call center associated with payment card benefits.

2. Description of the Related Art

Payment cards, such as credit, debit and prepaid cards, have become very popular for making purchases. A number of benefits can be associated with the use of the card, for example, rental car insurance, roadside assistance, extended warranty on purchases, price protection, emergency travel assistance, no foreign transaction fees, hotel and airline upgrades, and analogous types of benefits.

When a cardholder uses his or her card for a particular transaction, the cardholder may be unable to remember, or is not familiar with, benefits that may associated with the use of the card for the particular transaction. It is difficult for a consumer to store or remember the benefits associated with the use of a particular card, especially if the consumer has multiple cards, each having a particular set of benefits.

A simple system and/or method for determining credit and debit card benefits would be very advantageous to the consumer by enabling the consumer to take advantage of available benefits from use of the payment card. It would provide peace of mind for the consumer. It could also offer the advantage of cost savings to the consumer for particular transactions to which one or more benefits may be applicable.

### SUMMARY OF THE DISCLOSURE

There is provided a system and method for quickly and efficiently determining payment card benefits.

There is provided such a system and method in which the credit card benefits include, but are not limited to rental car insurance, roadside assistance, extended warranty on purchases, price protection, emergency travel assistance, no foreign transaction fees, and hotel and airline upgrades.

There is also provided a system and method designed to secure payment card benefits to give the cardholder peace of mind, especially in the event of a lost or stolen card.

There is further provided a mobile application designed to provide a cardholder with the ability to lookup their associated payment card benefits by entering a desired number of digits.

There is still further provided such a mobile application that lockup associated payment card benefits by entering the first six (6) digits of the card (i.e., BIN or bank identification number) on a mobile device (e.g., iPhone® or Android® mobile devices).

### BRIEF DESCRIPTION OF THE DRAWINGS

FIG. 1 is block diagram of a system for implementing an exemplary embodiment of the present disclosure.

FIG. 2 is a flow chart illustrating the operation of the system of FIG. 1 in accordance the present disclosure.

A component or a feature that is common to more than one figure is indicated with the same reference number in each figure.

### DESCRIPTION OF THE PREFERRED EMBODIMENT

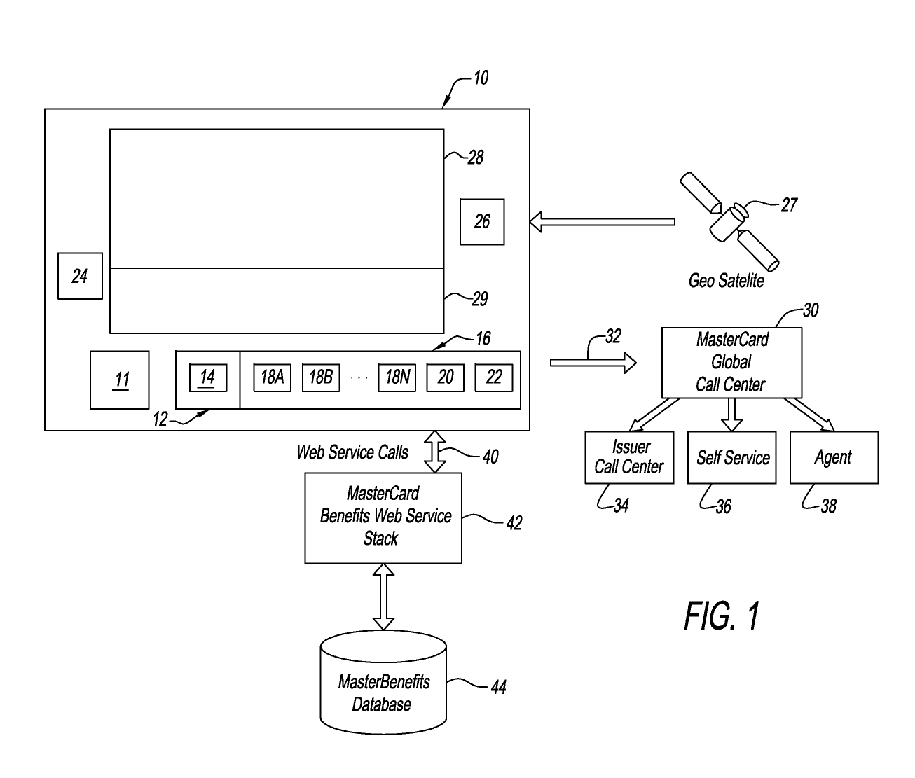

Referring to the drawings and, in particular, FIG. 1, a mobile communication device generally represented by reference numeral 10 is shown. In one embodiment of the present disclosure, communication device 10 is a smart mobile telephone. Communication device 10 has a data processor 11 and a memory 12. Memory 12 stores an operating system 14, and has a memory portion 16 for storing applications 18A, 18B, . . . 18N. One of these applications 18A, 18B, . . . 18N is a so-called peace of mind application 20 stored in memory portion 16. This application 20 provides services as disclosed herein. Memory 14 has a portion for storing a payment card profile 22, as opposed to a credit card number.

Communication device 10 includes voice synthesis and recognition services 24. Such voice and recognition services 24 are well known in the art. Communication device 10 also includes a location module 26, which may be a GPS receiver, to receive information from at least one satellite 27. Location module 26 provides information concerning the current location of communication device 10. The current location data may be used to direct telephone calls or Internet communications to the appropriately located call center or web site to facilitate communication. Further features of communication device 10 include a viewing screen 28 and a keyboard 29. Keyboard 29 can have actual keys, in the manner of a smart mobile telephone, or may be a virtual keyboard on screen 28, if screen 28 is configured as a touchscreen.

Communication device 10 can communicate with a global call center 30 via a telephone connection 32 made using standard mobile telephone technology. Call center 30 redirects the call to a payment card issuer call center 34, a self-service call center 36 or an answering agent, represented by 38, depending either on the cardholder's preference or the service that is available. Call center 30 has access (not shown in FIG. 1) to a master benefits database at 44 to assist in processing calls from communication device 10.

Communication device 10 may also communicate via the Internet, as represented by Internet connection 40. A benefits web service stack web site 42 responds to internet access by communication device 10. Web site 42 also has access to a master benefits database 44 to assist in processing web based inquiries from communication device 10.

Call center 30 and web site 42 may be operated by MasterCard®, the assignee of the present application. MasterCard® operates what is known as a “four-party” open payment card system. The four key participants in a four-party system are: (i) the consumer and business cardholders that use the cards; (ii) the merchants that accept the cards; (iii) the financial institutions that issue the cards (referred to as the card issuer); and (iv) the financial institutions that sign up merchants to accept the cards (referred to as the acquirer).

While access to web site 42 is most conveniently provided by communication device 10 in the form of a mobile telephone, in appropriate circumstances web site 42 may be accessed from a home or business computer, a personal digital assistant, any other Internet connected communication device, such as, a tablet or other mobile device (for example, an iPad® or an Ultrabook), or any stationary device, such as, for example, a kiosk.

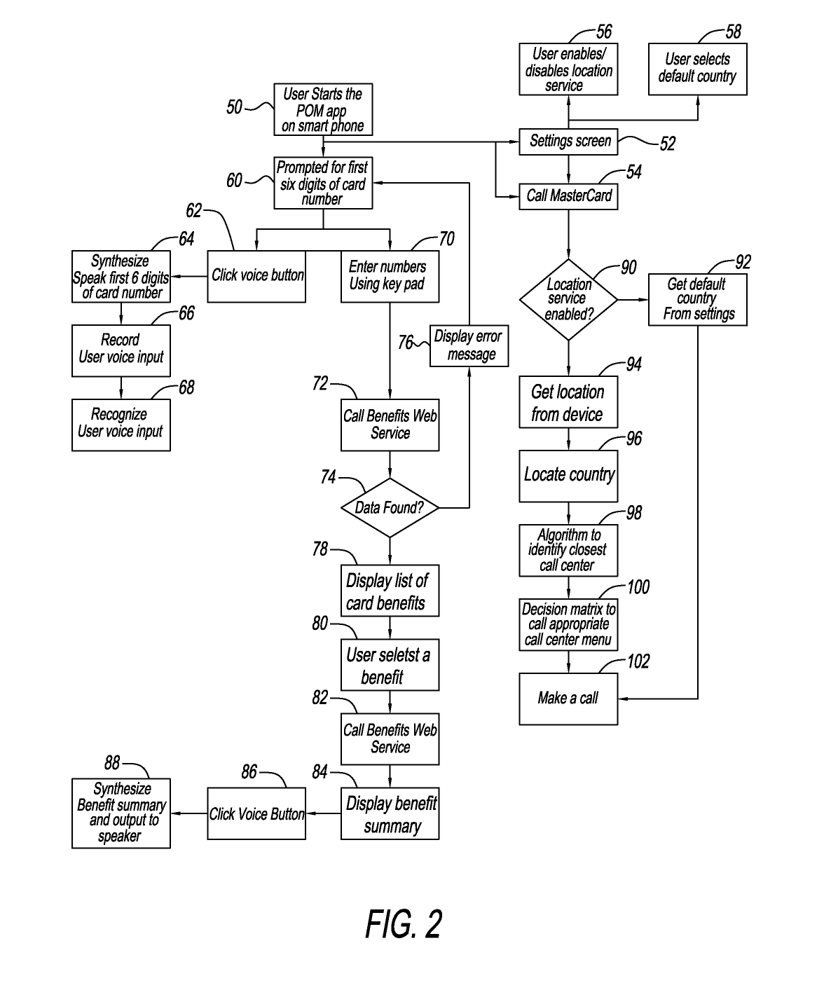

Referring to FIG. 2, at 50, a customer of the system and method of the present disclosure invokes the peace of mind application 20 on communication device 10. The customer has the option on a home screen of calling up a settings screen at 52, so that user can customize settings for the peace of mind application 20. Such customized settings include, but are not limited to, customer identification information, a password if desired, what functions of the peace of mind application 20 will be utilized, and screen configurations settings, such as size of type. At 54, the customer is provided with the option of calling the operator of the payment card system via the global call center 30 of FIG. 1 for any assistance that the customer requires in setting up the peace of mind application 20, or for other reasons as described below.

An access path for allowing access to payment card benefit information is shown in FIG. 2. At 50, after a customer invokes the peace of mind application 20, and the customized settings have been applied to the peace of mind application 20 as described above, the customer is prompted on communication device 10 to enter the first six (6) digits of the payment card (i.e., BIN or bank identification number) at 60. [Question: Must it be at least six digits; can it be more digits?] The first six (6) digits of the payment card can be provided by two different methods. One method is speaking which involves clicking the voice button at 62 on the communication device 10, synthesize by speaking the six (6) digits at 64 into the communication device 10, recording the user voice input at 66 and recognizing the user voice input at 68. Another method involves, at 70, manual entry on a keyboard of the first six (6) digits of the payment card by entering the number on the keypad or keyboard 29 of communication device 10.

After the user voice input is recognized at 68 on communication device 10, or alternatively after entering the first six (6) digits of the payment card on the keypad or keyboard 29 of communication device 10, a call is made to the benefits web service at 72. At 74, if no data is found from the call to the benefits web service at 72, an error message is displayed at 76 and sent back to 60 where the user will be prompted for the first six (6) digits of the payment card again. The user will then repeat the steps for accessing the benefits web service at 72 so that a determination can be made again as to whether data can be found. If the data is found at 74, then a list of the card benefits will be displayed at 78 on a screen of the peace of mind application 20 of communication device 10. At 80, the benefit for the payment card is selected by the customer from a list that is provided on a screen of the peace of mind application 20 of communication device 10.

After a benefit for the payment card is selected at 80, a coding request for the selected benefit is made to the benefits web service at 82. A summary of the particular benefit selected by the user is displayed at 84. Such benefits include, but are not limited to, rental car insurance, roadside assistance, extended warranty on purchases, price protection, emergency travel assistance, foreign transaction fees, and hotel and airline upgrades. The benefit summary is provided on a screen of the peace of mind application 20 on communication device 10. A voice button can be clicked at 86 and synthesize the benefit summary and output to speaker at 88.

An electronics storage device having a database of payment card benefit information stored therein is included in the benefits web service at 72 and 82. A processor for assembling the payment card benefit information in the database, and for providing the assembled payment card benefit information to a cardholder that has been granted access to the database, is also included in the benefits web service at 72 and 82.

The customer has an option of proceeding to 54 to call an agent at global call center 30. The customer will use this if the customer wants to engage services that are not routine, such as, for example, changing or adding a benefit if still possible, further clarification of a benefit, or other tasks that require the intervention of a human being.

The system and method described herein allows customers to access available benefits in a quickly and simple manner, with just a few clicks or operations of a simple application on a communication device. The customer need not remember any payment card or call center contact information if the customer chooses not to do so. The customer can be routed to an appropriate geographic call center and to an agent based on the customer's needs.

The customer may decide not to proceed to 54 and, therefore, not call an agent at global call center 30, but instead invoke the location service feature. To invoke the location service feature and, for example, be routed to an appropriate geographic call center and to an agent based on the customer's needs, the customer is provided with the option on the home screen of calling up a settings screen at 52. At 52, the user customized settings can be applied to the peace of mind application 20. At the settings screen 52, the customer can enable or disable the location service at 56 and can also select a default country at 58.

If the location service is enabled at 90, the customer can receive the location of the call center from the mobile device at 94. The selected country can be located at 96. An algorithm can be used to identify the closest call center at 98. At 100, a decision matrix to call the appropriate call center menu in the selected country is made available to the customer. The customer call can then be made to the desired call center at 102 for the selected country.

If the location service is not enabled at 90, the customer will get a default country from default country setting at 58. At 100, a decision matrix to call the appropriate call center menu in the default country is made available to the customer. The customer call can then be made to the desired call center at 102 for the default country.

The ability to access benefits associated with payment cards quickly increases consumer confidence. The potential cost savings to the customer resulting from a prudent use of benefits associated with payment cards is very attractive to customers. Thus, the customer is more likely to use the payment cards with this acquired knowledge of the benefits associated therewith.

In addition to determining benefits associated with payment cards, the peace of mind application 20 can provide protection to a cardholder in the event of a lost or stolen card. For example, a system and method for allowing a cardholder to quickly and easily report a lost or stolen payment card, and to request a replacement card, is described in copending U.S. patent application Ser. No. (Attorney Docket No. 0008759USU/4450), filed on an even date herewith, which is incorporated herein in its entirety.

The system and method disclosed herein can be a stand-alone offering, or can be integrated into various financial products such as, for example, a digital wallet, other electronic payment systems and various mobile offerings.

The system and method disclosed herein allow the benefits to be accessed with a mobile platform or device. If appropriate, a service charge can be imposed on a monthly or yearly basis for the convenience of use of the system and method disclosed herein. Payment cards are likely to be more popular if this service is available. Again, a customer that uses the system and method disclosed herein will have peace of mind.

It will be understood that the present disclosure may be embodied in a computer readable non-transitory storage medium storing instructions of a computer program that when executed by a computer system results in performance of steps of the system or method described herein. Such storage media may include any of those mentioned in the description above.

In particular, there is provided a computer readable non-transitory storage medium storing instructions of a computer program, which when executed by a computer system, results in performance of steps of: storing in an electronic storage device a database of payment card benefit information; accessing the database; and providing information concerning the payment card benefit to a cardholder that has been granted access to the database.

The computer readable non-transitory storage medium can further comprise instructions of a computer program for configuring the database to store, at least in part, data associated with a geographical area benefits call center.

The terms “comprises” or “comprising” are to be interpreted as specifying the presence of the stated features, integers, steps or components, but not precluding the presence of one or more other features, integers, steps or components or groups thereof.

It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A system for determining benefits associated with a payment card, said system comprising:
an electronic storage device having a database of payment card benefit information stored therein;
an access path for allowing access to the payment card benefit information; and
a processor for assembling the payment card benefit information in the database, and for providing the assembled payment card benefit information to a cardholder that has been granted access to the database.

2. The system of claim 1, wherein access to the database is granted through a communication device in which the first six (6) numbers of a bank identification number (BIN) are entered into the communication device, and a comparison is made between the BIN of the communication device and the BIN previously entered into the electronic storage device, to authenticate the contact.

3. The system of claim 1, wherein the access path comprises a web site for making the data available to a user of the web site.

4. The system of claim 3, wherein the access path includes an Internet connected device for connecting to the web site.

5. The system of claim 3, wherein said Internet connected device is one selected from the group consisting of a mobile telephone, a computer, a tablet, and a personal digital assistant.

6. The system of claim 1, wherein the communication device further comprises a location module for determining location of the communication device.

7. The system of claim 6, wherein the location module is a GPS receiver.

8. The system of claim 6, wherein the communication device uses the location that is determined to specify a call center to be contacted by the communication device when determining payment card benefits.

9. The system of claim 1, wherein the communication device is configured as a mobile platform.

10. The system of claim 1, wherein the payment card benefit information comprises one or more information selected from the group consisting of rental car insurance, roadside assistance, extended warranty on purchases, price protection, emergency travel assistance, foreign transaction fees, hotel upgrades, and airline upgrades.

11. A method for determining benefits associated with a payment card, said method comprising:
providing an electronic storage device having a database of payment card benefit information stored therein;
allowing access via an access path to the payment card benefit information;
assembling in the database via a processor the payment card benefit information; and
providing the assembled payment card benefit information to a cardholder that has been granted access to the database.

12. The method of claim 11, wherein allowing access to the database is granted through a communication device in which the first six (6) numbers of a bank identification number (BIN) are entered into the communication device, and a comparison is made between the BIN of the communication device and the BIN previously entered into the electronic storage device, to authenticate the contact.

13. The method of claim 11, wherein the communication device further comprises a location module for determining location of the communication device.

14. The method of claim 13, wherein the location module is a GPS receiver.

15. The method of claim 13, wherein the communication device uses the location that is determined to specify a call center to be contacted by the communication device when determining payment card benefits.

16. The method of claim 11, wherein the communication device is configured as a mobile platform.

17. The method of claim 11, further comprising contacting a human agent for assistance.

18. The method of claim 11 wherein the payment card benefits comprise one or more benefits selected form the group consisting of rental car insurance, roadside assistance, extended warranty on purchases, price protection, emergency travel assistance, foreign transaction fees, hotel upgrades, and airline upgrades.

19. A system for determining geographic location of a call center associated with payment card benefits, said system comprising:
an electronic storage device having a database of call center geographic location information stored therein;
an access path for allowing access to the call center geographic location information; and
a processor for assembling the call center geographic location information in the database, and for providing the assembled call center geographic location information to a cardholder that has been granted access to the database.

20. A method for determining geographic location of a call center associated with payment card benefits, said method comprising:
providing an electronic storage device having a database of call center geographic location information stored therein;
allowing access via an access path to the call center geographic location information;
assembling the call center geographic location information in the database, and
providing the assembled call center geographic location information to a cardholder that has been granted access to the database.
